(19) United States
(12) Patent Application Publication
(10) Pub. No.: US 2012/0279483 A1
(43) Pub. Date: Nov. 8, 2012

(54) T-SHIRT CANNON

(75) Inventors: Tristan James Hase, Milnor, ND (US); Reid Dale Anderson, Fargo, ND (US); Orrin Christian Hanson, Oakes, ND (US); Brandon Lee Steinhauer, Thief River Falls, MN (US)

(73) Assignee: Wrath Systems LLC, Milnor, ND (US)

(21) Appl. No.: 13/464,683

(22) Filed: May 4, 2012

Related U.S. Application Data
(60) Provisional application No. 61/482,444, filed on May 4, 2011.

(51) Int. Cl. F41B 11/02; B23P 11/00; F41B 11/32

(52) U.S. Cl. 124/77; 124/56; 29/890.09

(57) ABSTRACT

A system and method for launching promotional material is described. A gas-powered cannon having an actuation system and a magazine attached to the actuation system is provided. The magazine includes a plurality of tubes capable of receiving the promotional items to be launched. A promotional item is loaded into each tube, wherein loading includes loading a first promotional item in a first one of the plurality of tubes and loading a second promotional item into a different one of the plurality of tubes. The first promotional item is launched and then the magazine is rotated around the actuation system under gas power to line up the second promotional item. The second promotional item is then launched.

### CLAIM OF PRIORITY

This patent application claims the benefit of priority, under 35 U.S.C. §119(e), to U.S. Provisional Patent Application Ser. No. 61/482,444, entitled “T-SHIRT CANNON,” filed on May 4, 2011, which is hereby incorporated by reference herein in its entirety.

### BACKGROUND

T-shirt cannons are made specifically for fan and spectator entertainment around the world. They are a unique and crowd entertaining way to market your team or company. They operate like a paintball gun. That is, a compressed gas source, controlled through the use of valves and regulators, propels a t-shirt from the cannon. To use, a t-shirt or other promotional item is loaded into the barrel. When the trigger is activated, gas from the compressed gas source is released into the barrel of the cannon. The compressed gas expands out through the barrel, which in turn propels the t-shirt from the barrel. These custom crafted tools are used to launch t-shirts or other promotional items to fans, spectators, and employees.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example t-shirt cannon;

FIG. 2 is an exploded view of the t-shirt cannon of FIG. 1;

FIG. 3 is a block diagram of a pneumatic system that can be used in the t-shirt cannon of FIG. 1;

FIG. 4 illustrates an actuation system that can be used in the t-shirt cannon of FIG. 1;

FIG. 5 illustrates an example magazine and actuator interface;

FIG. 6 illustrates a frame and barrel system that can be used in the t-shirt cannon of FIG. 1;

FIG. 7 illustrates a magazine assembly that can be used in the t-shirt cannon of FIG. 1;

FIG. 8 illustrates a detent system at can be used in the magazine system of FIG. 7;

FIG. 9 illustrates a ratchet system that can be used in the magazine system of FIG. 7;

FIG. 10 illustrates an electrical system that can be used in the t-shirt cannon of FIG. 1; and

FIG. 11 illustrates a handle assembly system that can be used in the t-shirt cannon of FIG. 1.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

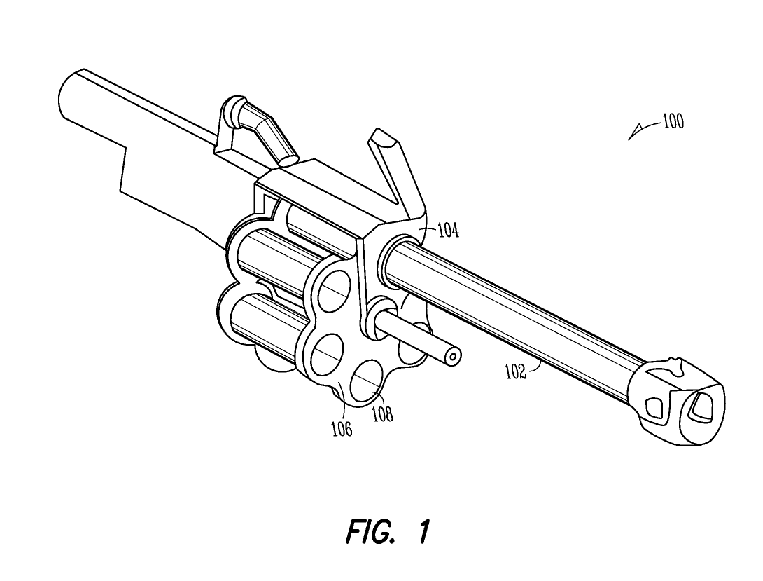

A gas-powered cannon 100 is shown in FIG. 1. In the example shown in FIG. 1, cannon 100 includes a barrel 102 connected through a frame 104 to magazine 106. Cannon 100 also includes a high pressure chamber attached to the frame. The high pressure chamber provides power to magazine 106.

In the embodiment shown, magazine 106 includes a plurality of tubes 108 mounted around an actuator 110. In one such embodiment, tubes 108 are mounted adjacent to actuator 110. Actuator 110 is connected to the high pressure chamber such that actuator 110 moves under gas power to rotate magazine 106 such that promotional items placed inside each tube 108 are lined up to be launched. The result is a revolver-style cannon capable of launching multiple promotional items over a short period of time. The revolver-type cannon design adds much excitement to the industry.

In one embodiment, cannon 100 uses a compressed gas to launch promotional items. In one such embodiment, a large-volume chamber pressurized with an air compressor or a regulated CO2 tank, and a fast-acting dump valve are used to provide propulsion. The valve, when tired, dumps that entire amount of air into barrel 102, sending the promotional item projectile down the barrel at great velocities.

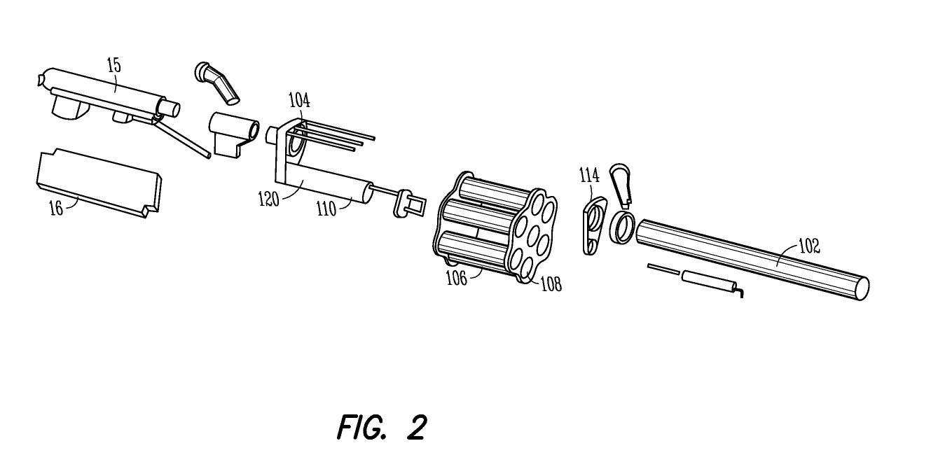

An exploded view of cannon 100 is shown in FIG. 2. In the embodiment shown in FIG. 2, frame 104 is configured to receive actuation tube 110. Magazine 106 is mounted to actuation tube 110. In the embodiment show, magazine 106 includes a plurality of tubes 108 that rotate around actuation tube 110. Actuation tube 110, when activated, rotates the magazine under gas power to position one of the tubes 108 so that an item placed in the tube is lined up to be launched.

In the example embodiment shown in FIG. 2, a bracket 114 is mounted to frame 104 and actuation tube 110 to hold magazine 108 in place. In one such embodiment, barrel 102 is connected in turn to bracket 114 to provide additional accuracy to cannon 100.

In one embodiment, cannon 100 includes a pneumatic air system having air lines, connection fittings, three regulators, an air source adapter, a low pressure tank (15, 16) at 150 psi output and a high pressure 90 cubic in. carbon fiber air tank capable of outputting 4500 psi and an aluminum 2-way air cylinder used for the actuation. In one embodiment, the high pressure air tank is modified to output around 450 psi.

In one such embodiment, most of the components are either made out of aluminum or plastic. In addition, in some such embodiments, the low pressure air tank 116 acts as storage for the various regulators and electronics necessary to power the system.

In one embodiment, cannon 100 includes a handle mount (4, 14) designee to enable the use of a pre-made electronic control grip.

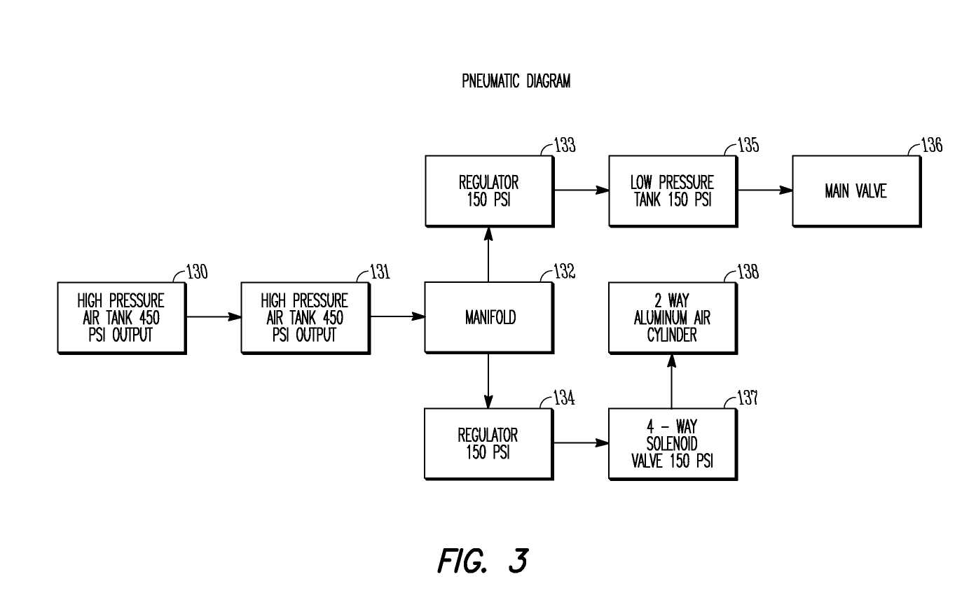

In one embodiment, brass air valve (13) is able to handle a max pressure of 150 psi and is capable of producing large mass flow rates. A block diagram of a representative pneumatic system is shown in FIG. 3.

In the example embodiment shown in FIG. 3, high pressure tank 130 is connected through regulator 131 to a manifold 132. The manifold is connected to two regulators (133 and 134) that feed actuation tube 110 and low pressure tank 135, respectively. Low pressure tank 135 supplies the gas to propel the promotional item from tube 108 through main valve 136. Solenoid valve 137 supplies gas to a 2-way aluminum air cylinder 138 in actuation tube 110.

In one embodiment, regulators within cannon 100 the adjustment of exit or muzzle velocity.

The low pressure tank 135 is the part of the cannon that holds the compressed air that is waiting to fire the t-shirt. In one example embodiment, the tank has a volume of 130 cubic inches. To construct the tank, we chose 3 inch schedule 10 aluminum pipe. This pipe was relatively inexpensive and we are able to fabricate it in-house. The max pressure that our tank has to hold is 150 psi. This is limited by the valve that we chose to use. Since pressure higher than 150 psi could damage our valve, we designed our tank around that pressure. The aluminum that the tank is made out of is 6063-T6 aluminum with yield strength of 31,000 psi. The 3 inch schedule 10 pipe has an outside diameter of 3.5 inches and a wall thickness of 0.12 inches.

To regulate the air pressure in our pneumatic system we use a series of three regulators. We needed to use three because the air coming out of our tank is at 450 psi. This is too high for conventional regulator like those found on an air compressor. That is why the first regulator in our system is a meant for use on a paintball gun. It is able to handle input pressures of up to 850 psi while being able to output anything below that. Our design calls for an input or 450 psi and an output of 150. After the paintball regulator, we split the system into two separate regulators. These regulators have maximum inputs of 150 psi. With these two separate regulators we can adjust the air pressure going to the pneumatic actuator and the low pressure tank separately. This allows us to change the distance we shoot a t-shirt and still have the machine actuate properly.

To control the air cylinder that actuates the magazine, we use a 4 way solenoid valve 137. The purpose of the solenoid valve is to direct the air to the two different chambers in the air cylinder 138 that makes our magazine rotate. In one example embodiment, the solenoid is a Numatics brand solenoid valve that uses a 24 volt DC solenoid to actuate the valve. We chose this solenoid because it allows us to have input pressures of up to 150 psi.

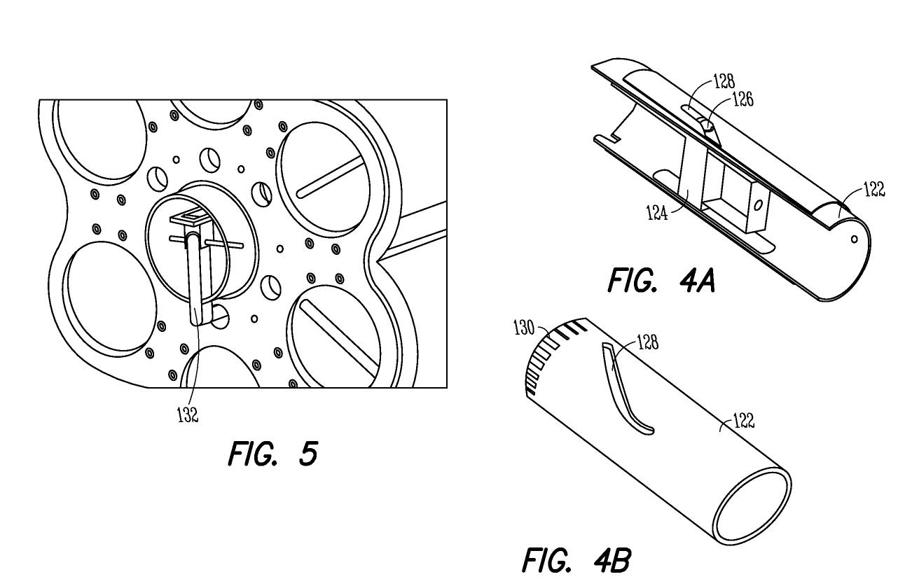

In one embodiment, cannon 100 includes an actuation system 120 that includes actuation tube 110. In one embodiment, such as is shown in FIG. 4a, actuation system 120 includes two or more actuation tubes. In one embodiment, as is shown in FIGS. 4a and 4b, actuation system 120 includes a steel actuation tube 122 with 24 teeth 130 located at the aft end of the tube 122.

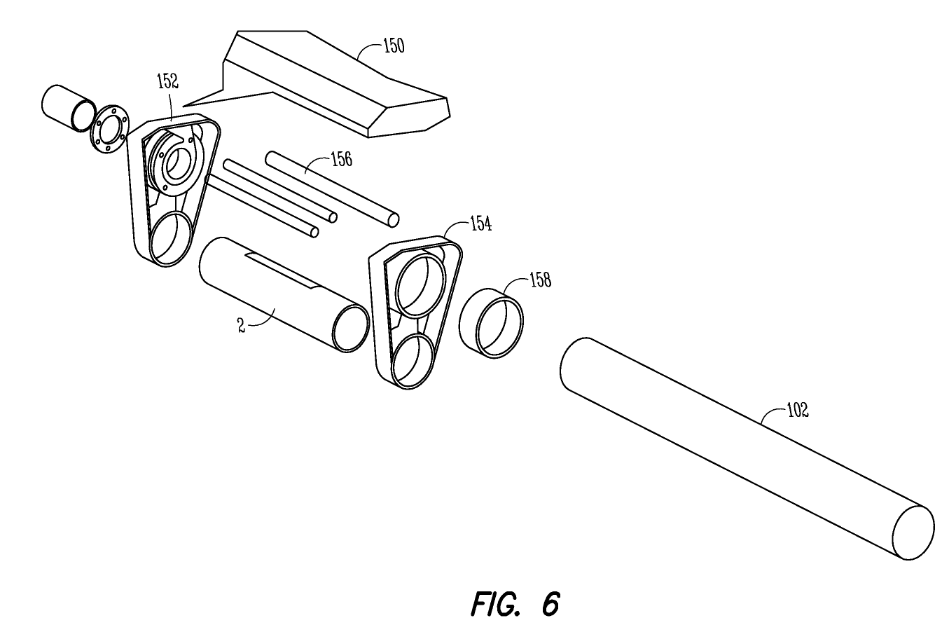

In the example embodiment shown in FIG. 4a, actuation system 120 includes a push block 124 inserted in actuation tube 122. In the embodiment shown, push block 124 is attached to a linear actuator 126. In one such embodiment, actuation system 120 fits within and is mechanically coupled to actuation tube 2 in FIG. 6. Actuation system 120 turns magazine 106 by turning actuation tube 2 as push block 124 traces cutout 128. In one example embodiment, gas from high pressure tank 130 is used to drive push block 124 through a predefined path defined by cutout 128. As the air cylinder moves linearly, the push block moves through the profile of the tube. In one such embodiment, cutout 128 defines the maximum stroke of push block 124 and, therefore, defines the rotation of actuator 110 and magazine 106. For the six tube magazine shown in FIGS. 1, 2 and 5, cutout 128 is sufficient to rotate magazine 106 sixty degrees after each launch.

The first step in sizing our components in the actuation system was to calculate the torque required to index the magazine to the next slot in a given amount of time. To do this, we set up a spreadsheet that calculates the torque required based on the time we want the indexing to take and the mass moment of inertia of the magazine itself.

Once we had a way to calculate the torque required to actuate the system, we needed away to turn the linear motion of an air cylinder into rotation for the magazine. The ratchet tube we designed has two helical slots cut in it that allow a pin to travel down the slot and turn the magazine. A critical component in this system is the pin that travels down the slot. To size this pin and thus the slot in the ratchet tube we made another spreadsheet. This spreadsheet has the torque required from the previous calculation as well as the geometry of the ratchet tube to calculate the forces on the pin. We decided to use a 0.375 grade 8 bolt for this pin. To allow these pins to rotate as they travel down the groove in the ratchet tube, we installed bearings in the push block that hold the pins in place and allow them to rotate.

In the embodiment shown in FIG. 5, a hammer switch 132 is mounted after magazine 106 is mounted on frame 104 and actuator 110. The hammer switch locks the magazine into place to ensure the magazine doesn't rotate without it being energized. In the embodiment shown, hammer switch 132 holds magazine 106 in place as actuator 110 rotates such that magazine 106 rotates as well.

An exploded view of frame 104 and barrel 102 is shown in FIG. 6. In the example embodiment shown in FIG. 6, frame 104 includes a top plate 150, end plates 152 and 154, connecting rods 106 and Teflon wear surfaces 158. In one example embodiment, end plates 152 and 154 are manufactured from 6061-T6 aluminum. The end plates have an overall thickness of 1″ while the rods have a diameter of ⅜″. The Teflon wear surfaces 158 were designed to act as seals between frame 104 and magazine 106. The wear surfaces are modeled to seat in the end plates trapping any air that may move by as the valve is energized. Lastly, the top plate 150 is 16 gauge 1018 steel with two bends to fit along the top surfaces of the end plates 152 and 154.

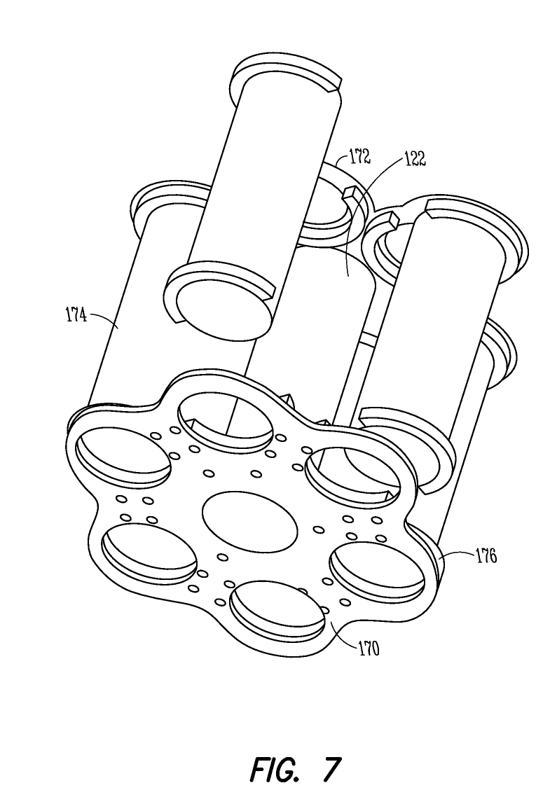

An exploded view of magazine 106 is shown in FIG. 7. In the example embodiment shown in FIG. 7, end plate 170 and 172 are ¼″ 6061-T6 aluminum, tubes 198 are 9.5″ woven carbon fiber cylinders 174 with ABS cylinder collars 176 and small steel ratchet teeth, located towards the center of magazine 106. The ¼ in. end plates 170 and 172 are designed to hold the rest of the components together. The 9.5″ woven carbon fiber tubes were cut to length and designed to hold the t-shirts while reducing weight significantly. The carbon fiber tubes weigh approximately 0.4 lbs. per foot. The tow impact ABS collars 176 were designed to secure the cylinders to the end plates.

In the event of a cylinder 108 failing, it is simply removed and replaced with anew cylinder 108. Lastly, the small teeth 182 are made of steel and were designed to catch the ratchet tube 122 to hold it into place. The ratchet system lets the tube rotate and then holds the magazine in place during launch.

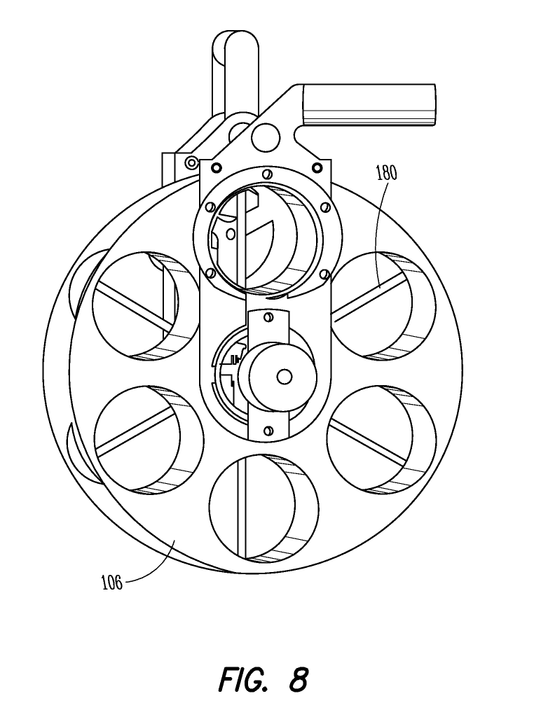

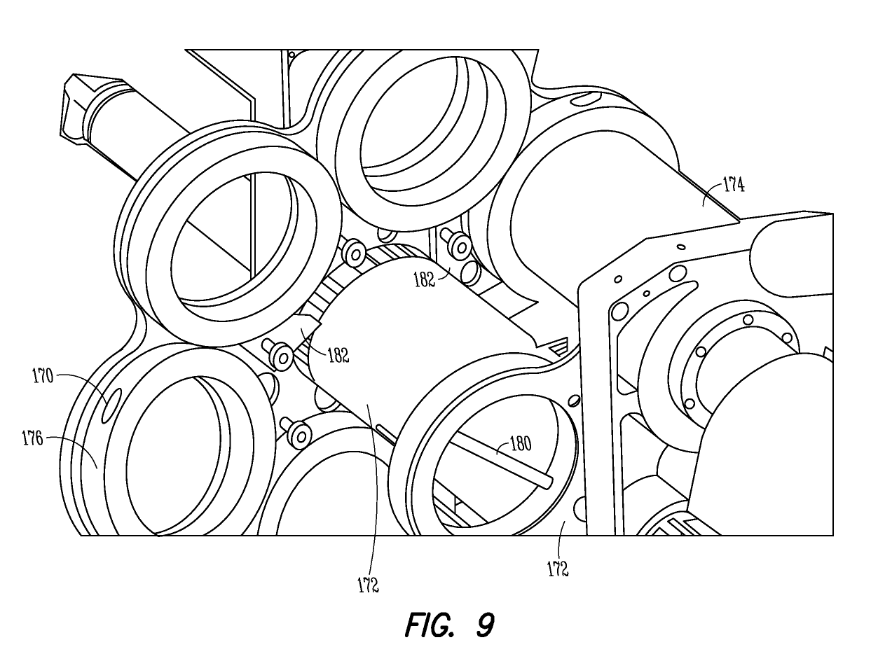

In the embodiment of magazine 106 shown in FIG. 8, each tube 108 includes a detent 180 used to stop the shirt from passing through tube 108.

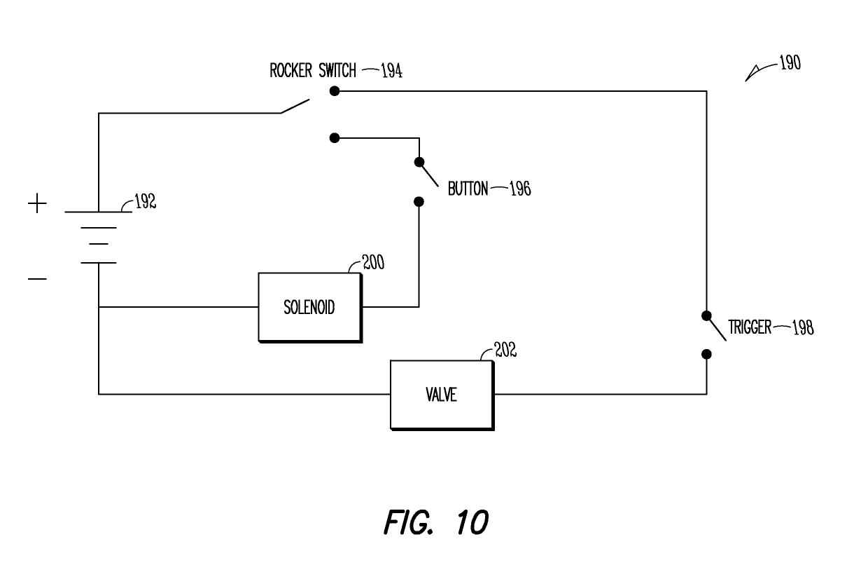

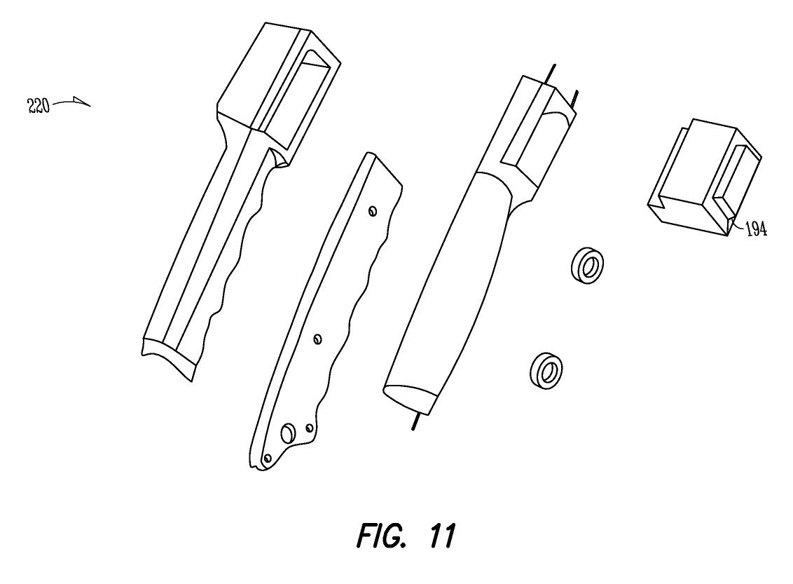

An example embodiment of an electrical system 190 such as could be used in cannon 100 is shown in FIG. 10. In the example shown in FIG. 10, batteries 190 power electrical system 190. Batteries 190 are connected to a rocker switch 194, a button 196, a trigger 198, a solenoid 200 and a valve 202 as shown in FIG. 10. In one embodiment, batteries 190 are 24 AA batteries @ 1 VAC. In one embodiment, 18 and 20 gauge wiring are used. The 24 AA batteries were picked for their ease of use, and all electrical components ran off of 24 VAC. The ability to change out batteries easily and quickly made this choice very simple. The design group elected to use a terminal block as well. It allows for clean and easy wired connections to be made.

In the example embodiment shown in FIG. 10; multiple switches are integrated in cannon 100 to insure that firing will not occur when the magazine 106 is rotating. By integrating the switches into control grips within cannon 100, we try to insure safe use.

One example embodiment of a rocker switch assembly 220 integrated into a control grip is shown in FIG. 11. In the example embodiment shown in FIG. 11, rocker switch 194 is mounted in the front handle of cannon 100. Overall, it takes two separate buttons on the entire system to activate any function. Furthermore, the buttons are separated such that each hand has to depress a button at the same exact time for any system to energize.

In one embodiment, weight of cannon 100 is reduced through the use of aluminum and composite materials. In one such embodiment, a smaller macro line replaces the steel industrial pressure lines to reduce weight in the assembly.

To use cannon 100, one would connect a high pressure tank to cannon 100, load shirts into tubes 108 and turn on electrical power switch. To actuate the magazine, one would press and hold the bottom toggle button on the front handle and then press and hold the button on the trigger to actuate magazine until a chamber is aligned with the barrel. To fire the cannon, one would then press and hold the top toggle button on front handle and then press and hold trigger on rear handle to fire (hold trigger until shirt has left the barrel). Repeat until all desired shots are tired. When done, one would deactivate high pressure tank, fire cannon 100 once to remove all pressure and then turn off electrical power switch.

What has been described is a novel gas-powered cannon for launching promotional items. Although specific embodiments have been illustrated and described herein, it will be appreciated by those of ordinary skill in the art that any arrangement which is calculated to achieve the same purpose may be substituted for the specific embodiments shown. The invention may be implemented in various modules and in hardware, software, and various combinations thereof, and any combination of the features described in the examples presented herein is explicitly contemplated as an additional example embodiment. This application is intended to cover any adaptations or variations of the example embodiments of the invention described herein. It is intended that this invention be limited only by the claims, and the full scope of equivalents thereof.

What is claimed is:

1. A gas-powered cannon for launching promotional items, the cannon comprising:
a frame;
an actuation system attached to the frame; and
a magazine attached to the actuator, wherein the magazine includes a plurality of tubes capable of receiving promotional items to be launched, wherein, when attached, the plurality of tubes are mounted adjacent to the actuation system; and
wherein, in operation, the actuation system is connected to a high pressure chamber such that the actuation system moves under gas power to rotate the magazine such that items placed inside each tube are lined up to be launched.

2. The cannon of claim 1, wherein the actuation system includes a push block and a cutout, wherein the push block is connected to the cutout such that it moves along a predefined path as defined by the cutout;
wherein the push block moves forward and back under gas pressure from the high pressure chamber along the path defined by the cutout.

3. The cannon of claim 2, wherein the actuation system further includes teeth, wherein the tubes are mounted in an assembly, and wherein, when attached to the actuation system, the assembly is coupled to the actuation system teeth via ratchets.

4. The cannon of claim 1, wherein the actuation system further includes teeth, wherein the tubes are mounted in an assembly, and wherein, when attached to the actuation system, the assembly is coupled to the actuation system teeth via ratchets.

5. The cannon of claim 1, wherein the actuation system includes two chambers, a push block and a solenoid valve, wherein the solenoid valve directs gas into the two chambers to move the push block back and forth within the actuation system.

6. The cannon of claim 1, wherein the actuation system includes two chambers, a push block, a cutout and a solenoid valve, wherein the solenoid valve directs gas into the two chambers to move the push block back and forth within the actuation system along a path defined by the cutout, wherein the movement causes the actuation system to rotate the magazine in a predefined manner.

7. A method of distributing promotional material, comprising:
providing a gas-powered cannon, wherein the gas-powered cannon includes an actuation system and a magazine attached to the actuation system, wherein the magazine includes a plurality of tubes capable of receiving the promotional items to be launched;
loading a promotional item into each tube, wherein loading includes loading a first promotional item in a first one of the plurality of tubes and loading a second promotional item into a different one of the plurality of tubes;
launching the first promotional item;
rotating the magazine to line up the second promotional item, wherein rotating includes activating the actuation system so that the magazine rotates around the actuation system; and
launching the second promotional item.

8. The method of claim 7, wherein the actuation system includes two chambers, a push block and a solenoid valve and wherein activating the actuation system includes directing gas into the two chambers via the solenoid valve to move the push block back and forth within the actuation system.

9. A method of assembling a gas-powered cannon for launching promotional items, the method comprising:
providing a frame;
mounting an actuation system to the frame; and
mounting a magazine to the actuation system, wherein the magazine includes a plurality of tubes that rotate around the actuation system;
wherein the actuation system, when activated, rotates the magazine around the actuation system under gas power to position one of the plurality of tubes so that an item placed in the tube is lined up to be launched.
